(19) United States
(12) Patent Application Publication
(10) Pub. No.: US 2026/0168535 A1
(43) Pub. Date: Jun. 18, 2026

(54) VEHICULAR WHEEL BEARING HAVING IMPROVED SEALING PROPERTY OF ENCODER

(71) Applicant: ILJIN GLOBAL Co.,Ltd, Seoul (KR)

(72) Inventors: Nam Gyu HA, Seoul (KR); Yong Won KIM, Seoul (KR); Tae Hee AN, Seoul (KR)

(73) Assignee: ILJIN GLOBAL Co.,Ltd, Seoul (KR)

(21) Appl. No.: 19/417,880

(22) Filed: Dec. 12, 2025

(30) Foreign Application Priority Data
Dec. 12, 2024 (KR) 10-2024-0185238

(51) Int. Cl. F16C 33/78; F16C 19/38

(52) U.S. Cl. CPC F16C 33/7823; F16C 19/383; F16C 2326/02

(57) ABSTRACT

A vehicular wheel bearing includes a wheel hub to which the vehicle wheel is mounted; at least one inner ring mounted to the wheel hub; an outer ring fixedly coupled to a vehicle-body-side member; a plurality of rolling elements configured to rotatably support the wheel hub and the inner ring relative to the outer ring; an outboard-side sealing member configured to perform sealing at an outer axial end portion of a bearing space in which the rolling elements are disposed; and an inboard-side sealing member configured to perform sealing at an inner axial end portion of the bearing space. The inboard-side sealing member includes an outer portion mounted to the outer ring in a press-fitted manner and an inner portion mounted to the inner ring in a press-fitted manner, and an encoder for wheel-speed detection is provided on one side of the inner portion.

### CROSS-REFERENCE TO RELATED APPLICATION

This application claims priority to Korean Patent Application No. 10-2024-0185238 filed on Dec. 12, 2024, the entire contents of which are herein incorporated by reference.

### TECHNICAL FIELD

The present invention relates to a vehicular wheel bearing for rotatably mounting and supporting a vehicle wheel to a vehicle body, and more particularly, to a vehicular wheel bearing configured such that a protruding portion is formed on an inner circumferential surface of an encoder to prevent foreign substances, such as moisture, from entering a press-fitting surface of a sealing member.

### DESCRIPTION OF THE RELATED ART

A wheel bearing is a device used for rotatably mounting and supporting a vehicle wheel to a vehicle body, and performs a function of connecting a rotating element, to which a vehicle wheel is mounted, to a non-rotating element fixed to a vehicle body through rolling elements such that the vehicle wheel is rotatably mounted and supported to the vehicle body.

Meanwhile, since wheel bearings are easily exposed to external foreign substances such as mud, moisture, or the like due to the nature of products mounted to and used with a vehicle wheel, the wheel bearings have a sealing member which prevents external foreign substances from entering the insides of the wheel bearings.

Referring to FIG. 1, a structure of a vehicular wheel bearing comprising a sealing member is shown exemplarily.

As shown in FIG. 1, a vehicular wheel bearing 10 may be configured so that a rotating element 20 to which a vehicle wheel is mounted is rotatably mounted to a non-rotating element 30 fixed to a vehicle body through rolling elements 40, and a sealing member 50 may be provided between the rotating element 20 and the non-rotating element 30 so as to prevent inflow of external foreign substances and leakage of internal grease.

Referring to FIG. 2, a sealing member 50 having a pack-seal structure [an inboard-side sealing member (the sealing member shown in portion A of FIG. 1)], which can be used in the vehicular wheel bearing 10, is exemplarily shown.

As shown in FIG. 2, the sealing member 50 may be composed of an outer portion 60 positioned radially outward and an inner portion 70 positioned radially inward. At least one of the outer portion 60 and the inner portion 70 may be provided with an elastic sealing portion 80, and a sealing lip(s) 82 formed on the elastic sealing portion 80 may be arranged to be in contact with or adjacent to a counterpart member so as to perform a sealing function.

Meanwhile, an encoder 90 may be provided on one side of the sealing member 50 and configured to detect a rotational speed of the wheel bearing by sensing, via a wheel speed sensor, a change in a magnetic field generated by rotation of the encoder 90.

For example, as shown in FIG. 2, the encoder 90 may be configured to be attached to an axial end portion of a slinger [in the embodiment shown in FIG. 2, the slinger corresponds to the inner portion 70] mounted to the rotating element of the wheel bearing 10.

However, in the case of the sealing member 50 having such an encoder-mounted structure, foreign substances such as moisture may enter between the inner portion 70 to which the encoder 90 is attached and a press-fitting surface of an inner ring, which may result in a problem in that sealing performance and/or mountability of the sealing member 50 may be deteriorated.

### DISCLOSURE OF THE INVENTION

### Technical Goals

The present disclosure has been made to address the above-described matters, and the present disclosure is for the purpose of providing a vehicular wheel bearing configured to prevent foreign substances, such as moisture, from entering a press-fitting surface of a sealing member by forming a protrusion on an inner circumferential surface of an encoder.

### Technical Solutions

Representative configurations of the present disclosure to achieve the above-described purpose are as follows.

According to an embodiment of the present disclosure, a vehicular wheel bearing for rotatably mounting and supporting a vehicle wheel to a vehicle body may be provided. The vehicular wheel bearing according to an embodiment of the present disclosure may comprise: a wheel hub to which the vehicle wheel is mounted and which rotates together with the vehicle wheel; at least one inner ring mounted to the wheel hub; an outer ring fixedly coupled to a vehicle-body-side member; a plurality of rolling elements configured to rotatably support the wheel hub and the inner ring relative to the outer ring; an outboard-side sealing member configured to perform sealing at an outer axial end portion of a bearing space in which the rolling elements are disposed; and an inboard-side sealing member configured to perform sealing at an inner axial end portion of the bearing space in which the rolling elements are disposed. According to an embodiment of the present disclosure, the inboard-side sealing member may comprise an outer portion mounted to the outer ring in a press-fitted manner and an inner portion mounted to the inner ring in a press-fitted manner, and an encoder for wheel-speed detection is provided on one side of the inner portion. According to an embodiment of the present disclosure, a protrusion extending radially inward may be formed on an inner circumferential surface of the encoder, the protrusion of the encoder may be formed to have an inner diameter smaller than an outer diameter of an outer circumferential surface of the inner ring to which the inner portion is mounted, in an undeformed state before assembly, and the protrusion of the encoder may be configured to contact the inner ring in an assembled state.

According to an embodiment of the present disclosure, an axially inner portion of the protrusion may be provided with a stepped portion having a structure recessed radially outward.

According to an embodiment of the present disclosure, the stepped portion may comprise an axial end surface perpendicular to a rotational central axis of the wheel bearing and an inner circumferential surface parallel to the rotational central axis of the wheel bearing, and the inner circumferential surface of the stepped portion may be formed to have a diameter larger than that of the outer circumferential surface of the inner ring to which the inner portion is mounted.

According to an embodiment of the present disclosure, the stepped portion may comprise an axial end surface perpendicular to a rotational central axis of the wheel bearing and an inclined surface extending obliquely with respect to the rotational central axis of the wheel bearing.

According to an embodiment of the present disclosure, the protrusion may be configured to contact the inner ring with an interference amount of 0.1 mm or more.

According to an embodiment of the present disclosure, an axial length d from the axial end surface of the stepped portion to an axial end surface of the encoder may be 0.1 mm or more.

According to an embodiment of the present disclosure, the protrusion of the encoder may comprise a first protrusion positioned axially outward and a second protrusion positioned axially inward, and an inner circumferential surface of the second protrusion may be formed to have a diameter smaller than that of an inner circumferential surface of the first protrusion.

According to an embodiment of the present disclosure, the first protrusion and the second protrusion may be configured to respectively contact the inner ring at positions spaced apart from each other.

According to an embodiment of the present disclosure, each of the first protrusion and the second protrusion may be configured to contact the inner ring with an interference amount of 0.05 mm or more.

According to an embodiment of the present disclosure, the protrusion of the encoder may comprise a cylindrical portion, an inclined portion provided axially outward of the cylindrical portion, and a rounding portion provided axially inward of the cylindrical portion.

According to an embodiment of the present disclosure, the rounding portion may be formed as an arcuate structure having a radius of curvature of 0.1 mm or more.

According to an embodiment of the present disclosure, the protrusion may be configured such that at least one of the inclined portion and the cylindrical portion contacts the inner ring with an interference amount of 0.1 mm or more.

According to an embodiment of the present disclosure, the protrusion of the encoder may comprise an arcuate portion having a predetermined radius of curvature, and a chamfer portion positioned axially inward relative to the arcuate portion.

According to an embodiment of the present disclosure, the arcuate portion may be formed as an arcuate structure having a radius of curvature of 0.1 mm or more.

According to an embodiment of the present disclosure, the protrusion may be configured to contact the inner ring at the arcuate portion 960 with an interference amount of 0.1 mm or more.

In addition, the vehicular wheel bearing according to the present disclosure may further comprise other additional components to the extent that it does not impair the technical idea of the present disclosure.

### [Effects]

The vehicular wheel bearing according to one embodiment of the present disclosure may be configured such that a protrusion is formed on an inner circumferential surface of an encoder attached to an inboard-side sealing member, and the protrusion contacts an inner ring. Accordingly, it is possible to prevent foreign substances such as moisture from entering a press-fitting surface between the inboard-side sealing member and the inner ring, thereby improving mountability and/or sealing performance of the sealing member.

In addition, the vehicular wheel bearing according to one embodiment of the present disclosure is configured such that the protrusion formed on the inner circumferential surface of the encoder has a two-step stepped structure. With this configuration, the protrusion of the encoder can elastically deform in a more stable manner while contacting the inner ring and/or can contact the inner ring at a plurality of spaced positions, thereby more reliably preventing foreign substances such as moisture from entering the press-fitting surface between the sealing member and the inner ring.

Further, according to one embodiment of the present disclosure, in forming the protrusion on the encoder, one side of the protrusion is provided with an inclined structure (for example, a chamfered structure), and the other side is provided with a rounding structure. With this configuration, when the encoder is formed by a process such as vulcanization molding, smooth moldability of the encoder can be ensured while also ensuring that stable elastic deformation occurs in the protrusion.

### BRIEF DESCRIPTION OF THE DRAWINGS

FIG. 1 exemplarily shows a structure of a vehicular wheel bearing in the related art.

FIG. 2 exemplarily shows an example of a sealing member (for example, a sealing member having a pack-seal structure) which may be used in a vehicular wheel bearing.

FIG. 3 exemplarily shows a structure of a vehicular wheel bearing according to an example embodiment of the present disclosure.

FIG. 4 exemplarily shows a sealing member (an inboard-side sealing member) of a vehicular wheel bearing according to an example embodiment of the present disclosure.

FIGS. 5 to 8 exemplarily show other embodiments of a sealing member (an inboard-side sealing member) applicable to a vehicular wheel bearing according to the present disclosure.

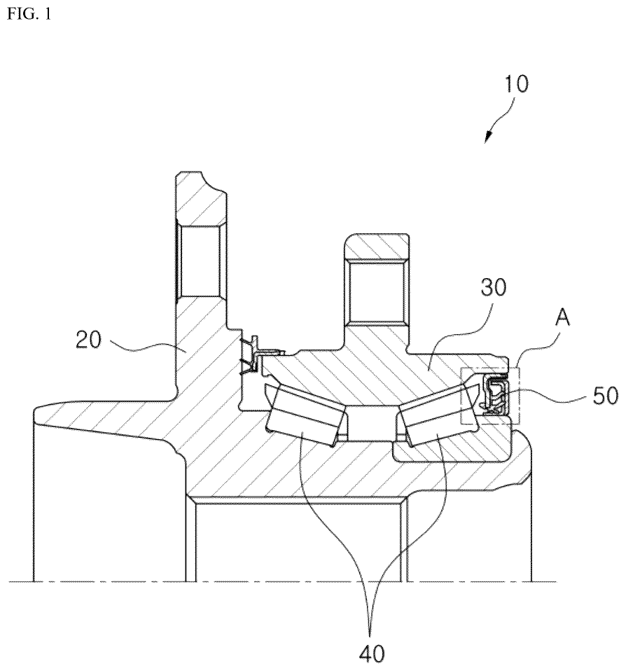

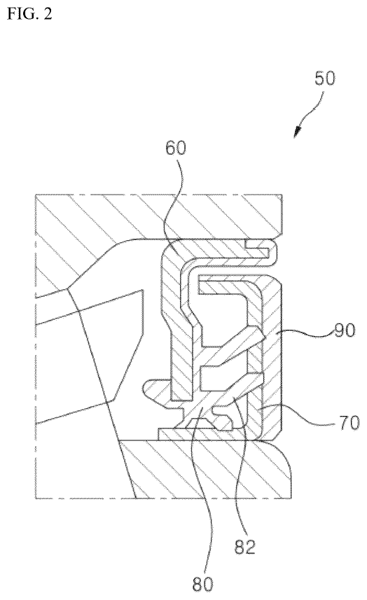

### DETAILED DESCRIPTION

Example embodiments of the present disclosure described herein are exemplified for the purpose of describing the technical spirit of the present disclosure. The scope of the claims according to the present disclosure is not limited to the example embodiments described below or to detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising,” “including,” “having,” and the like used herein should be construed as open-ended terms encompassing the possibility of including other example embodiments.

The term “axial direction” used herein may be defined as a direction extending along a rotational central axis of a wheel bearing. The term “radial direction” used herein may be defined as a direction perpendicular to the axial direction and away from the rotational central axis or approaching the rotational central axis. The term “circumferential direction” used herein may be defined as a direction rotating about the axial direction described above.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Unless the phrase or sentence clearly indicates otherwise, the expression “a constituent element extends in the axial direction, the radial direction or the circumferential direction” used herein should be understood as encompassing a case where the constituent element extends parallel to the axial direction, the radial direction or the circumferential direction as well as a case where the constituent element extends obliquely with respect to the axial direction, the radial direction or the circumferential direction.

Hereinafter, preferred embodiments of the present disclosure will be described in detail with reference to the accompanying drawings to such an extent that a person having ordinary skill in the art to which the present disclosure pertains can readily practice the present disclosure. In the accompanying drawings, the same reference numerals are assigned to the same or corresponding components. Furthermore, in the following descriptions of the example embodiments, duplicate description(s) of the same or corresponding constituent elements may be omitted. However, even if description(s) of a specific component is omitted in the following description, this is not intended to mean that such component is excluded from the corresponding embodiment.

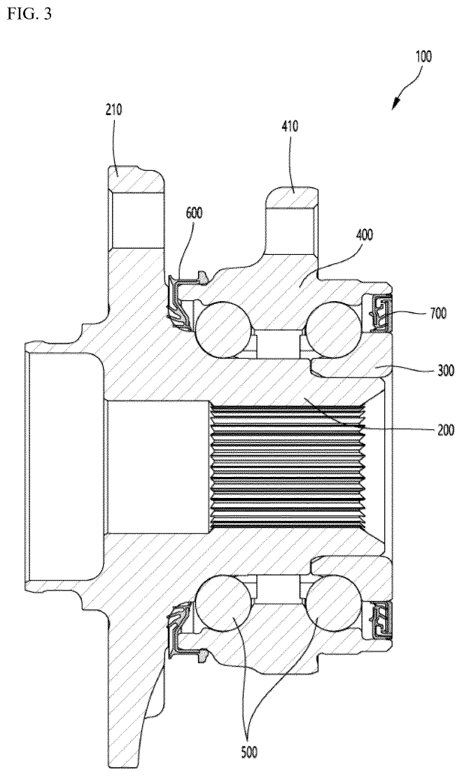

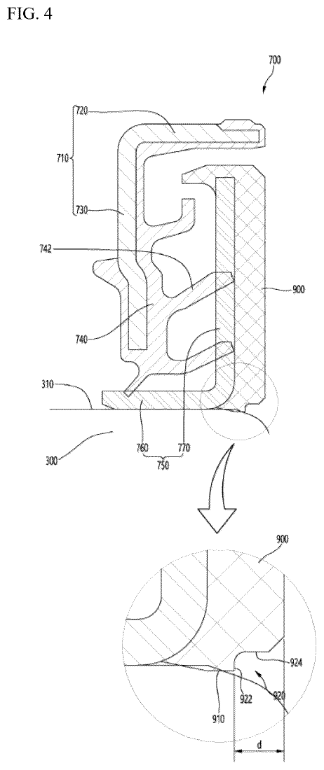

Referring to FIGS. 3 and 4, a structure of a vehicular wheel bearing according to an embodiment of the present disclosure and a structure of an inboard-side sealing member applicable to such a vehicular wheel bearing are exemplarily shown.

Similar to a conventional vehicular wheel bearings, a vehicular wheel bearing 100 according to an embodiment of the present disclosure may be configured such that a rotating element (for example, a wheel hub 200 and an inner ring 300), which rotates together with a vehicle wheel, is connected to a non-rotating element (for example, an outer ring 400), which is mounted to and fixed to a vehicle body, through a plurality of rolling elements 500.

According to an embodiment of the present disclosure, the wheel hub 200 constituting the rotating element of the wheel bearing may be formed in a substantially cylindrical shape extending along an axial direction, and a wheel-mounting flange 210 (hub flange) may be provided on an outer circumferential surface of the wheel hub 200. The wheel-mounting flange 210 may be formed to extend radially outward from the outer circumferential surface of the wheel hub 200 and may be used to mount a vehicle wheel to the wheel hub 200 using hub bolts or the like. Meanwhile, the inner ring 300 may be mounted at a vehicle-body-side end portion of the wheel hub 200, and a raceway surface (an inner raceway surface) may be formed on a portion of the outer circumferential surface of the wheel hub 200 so as to support the rolling elements 500 from a radially inner side.

According to an embodiment of the present disclosure, at least one the inner ring 300 may be mounted on a outer circumferential surfaces of the wheel hub 200, and a raceway surface (an inner raceway surface) for the rolling elements may be formed on the outer circumferential surface of the inner ring 300 so as to support the rolling elements 500 from a radially inner side. For example, the inner ring 300 may be configured to be press-fitted to a seating portion provided at a vehicle-body-side end portion of the wheel hub 200, and may be fixed on the wheel hub 200 in a state a predetermined preload is applied.

According to an embodiment of the present disclosure, the outer ring 400 constituting the non-rotating element of the wheel bearing may comprise, on an outer circumferential surface thereof, a vehicle-body-side mounting flange 410 for mounting the wheel bearing to a vehicle body, and may comprise, on an inner circumferential surface thereof, raceway surfaces (outer raceway surfaces) that contacts the rolling elements 500. The raceway surfaces (outer raceway surfaces) formed on the inner circumferential surface of the outer ring 400 may cooperate with the raceway surface (inner raceway surfaces) formed on the wheel hub 200 and/or the inner ring 300 to receive and support the rolling elements 500, which are rolling members, between the raceway surfaces.

According to an embodiment of the present disclosure, the rolling elements 500 may be disposed between a rotating element (for example, the wheel hub 200 and/or the inner ring 300) of the wheel bearing 100 and a non-rotating element (for example, the outer ring 400) of the wheel bearing 100, and may perform a function of rotatably supporting the rotating element of the wheel bearing 100 relative to the non-rotating element of the wheel bearing 100.

However, the above-described configurations of the vehicular wheel bearing 100 according to an embodiment of the present disclosure are not necessarily limited to the structures shown in the drawings, and may be variously modified into different structures applicable to vehicular wheel bearings.

For example, in the embodiment shown in the drawings, the vehicular wheel bearing 100 is configured such that one raceway surface for supporting the rolling elements 500 is directly formed on an outer circumferential surface of the wheel hub 200. However, the vehicular wheel bearing 100 according to an embodiment of the present disclosure may be implemented in other modified structures, such as a structure in which two inner rings 300 are mounted on the wheel hub 200 and the rolling elements 500 are supported by the two inner rings 300.

According to an embodiment of the present disclosure, sealing members for preventing inflow of external foreign substances may be provided at both axial ends of the vehicular wheel bearing 100.

According to an embodiment of the present disclosure, the vehicular wheel bearing 100 may comprise an outboard-side sealing member 600 configured to perform sealing at an outer axial end portion of a bearing space in which rolling elements 500 are disposed, and an inboard-side sealing member 700 configured to perform sealing at an inner axial end portion of the bearing space in which the rolling elements 500 are disposed.

According to an embodiment of the present disclosure, the outboard-side sealing member 600 may be configured in substantially the same or a similar manner as that of conventional vehicular wheel bearings and the vehicular wheel bearing 100 according to an embodiment of the present disclosure is not characterized by a specific structure of the outboard-side sealing member 600. Thus, detailed descriptions thereof will be omitted herein.

Meanwhile, referring to FIG. 4, a structure of an inboard-side sealing member 700 (for example, a sealing member having a pack-seal type structure) applicable to a vehicular wheel bearing 100 according to an embodiment of the present disclosure is exemplarily shown.

According to an embodiment of the present disclosure, the inboard-side sealing member 700 may comprise an outer portion 710 mounted to the outer ring 400 in a press-fitted manner and an inner portion 750 mounted to the inner ring 300 in a press-fitted manner.

According to an embodiment of the present disclosure, the outer portion 710 may be configured to comprise a cylindrical press-fitting portion 720 and a flange portion 730 extending radially from the cylindrical press-fitting portion 720, and may be press-fitted and mounted to an inner circumferential surface (or an outer circumferential surface) of the outer ring 400 by the cylindrical press-fitting portion 720.

According to an embodiment of the present disclosure, the inner portion 750 may be configured to comprise a cylindrical press-fitting portion 760 and a flange portion 770 extending radially from the cylindrical press-fitting portion 760, and may be press-fitted and mounted to an outer circumferential surface of the inner ring 300 by the cylindrical press-fitting portion 760.

According to an embodiment of the present disclosure, the outer portion 710 and the inner portion 750 may be formed in substantially the same or a similar manner as a sealing member having a pack-seal structure used in conventional vehicular wheel bearings, and may be formed, for example, by bending a metal plate.

According to an embodiment of the present disclosure, at least one of the outer portion 710 and the inner portion 750 of the inboard-side sealing member 700 may be provided with an elastic sealing portion 740 so that sealing is performed by the elastic sealing portion 740.

For example, the inboard-side sealing member 700 shown in the drawings is formed in a structure in which the elastic sealing portion 740 is provided on the outer portion 710, and the elastic sealing portion 740 is configured to perform sealing while interacting with the inner portion 750.

According to an embodiment of the present disclosure, the elastic sealing portion 740 may be configured to comprise one or more sealing lips 742, and an end of the sealing lip 742 may be arranged to be in contact with or adjacent to an opposing counterpart member so as to perform sealing.

According to an embodiment of the present disclosure, the elastic sealing portion 740 may be formed of an elastic material such as rubber, and may be integrally attached to and formed on the outer portion 710 and/or the inner portion 750 by a method such as vulcanization molding.

Meanwhile, according to an embodiment of the present disclosure, an encoder 900 for wheel-speed detection may be provided on the inner portion 750, which is mounted to the inner ring 300 serving as a rotating element of the wheel bearing.

According to an embodiment of the present disclosure, the encoder 900 may be integrally attached to and provided on an axially inner end surface of the flange portion 770 of the inner portion 750, as shown in FIG. 4.

According to an embodiment of the present disclosure, the encoder 900 may be formed of a material such as magnetized rubber, and may be integrally attached to and formed on the inner portion 750 by a method such as vulcanization molding.

According to an embodiment of the present disclosure, a protrusion 910 extending radially inward may be provided on an inner circumferential surface of the encoder 900.

According to an embodiment of the present disclosure, the protrusion 910 of the encoder 900 may be formed to have an inner diameter smaller than an outer diameter of an outer circumferential surface 310 of the inner ring 300 to which the inner portion 750 is press-fitted, in an undeformed state before assembly (that is, in a state of the sealing member as a single component before being press-fitted and assembled to the inner ring 300). In an assembled state of the inboard-side sealing member 700, the protrusion 910 of the encoder 900 may be positioned in contact with the inner ring 300.

With this configuration, due to contact between the protrusion 910 provided on the inner circumferential surface of the encoder 900 and the inner ring 300, a risk of foreign substances such as moisture entering a press-fitting surface between the inner portion 750 and the inner ring 300 can be reduced.

According to an embodiment of the present disclosure, as shown in FIG. 4, the protrusion 910 of the encoder 900 may be formed to have an inner circumferential surface of a substantially cylindrical structure, and an axially outer portion thereof may be provided with an inclined structure in which a diameter increases toward an axially outer side.

According to an embodiment of the present disclosure, the encoder 900 may be configured to comprise a stepped portion 920 having a structure recessed radially outward at an axially inner portion of the protrusion 910.

As described above, when the stepped portion 920 is provided at the axially inner portion of the protrusion 910, during a process of press-fitting the inboard-side sealing member 700 to the inner ring 300, a deformed portion of the protrusion 910 generated as the protrusion 910 comes into contact with the inner ring 300 can enter into the stepped portion 920, thereby enabling more stable elastic deformation.

According to an embodiment of the present disclosure, an axial end surface 922 of the stepped portion 920 may be formed to be substantially perpendicular to a rotational central axis of the wheel bearing (that is, substantially perpendicular to an outer circumferential surface 310 of the inner ring 300 to which the inner portion 750 is mounted).

According to an embodiment of the present disclosure, an inner circumferential surface 924 of the stepped portion 920 may be formed to be substantially parallel to the rotational central axis of the wheel bearing, and may be formed to have a diameter larger than that of the outer circumferential surface 310 to which the inner portion 750 is mounted. Further, an axial length d from the axial end surface 922 of the stepped portion 920 to an axially inner end surface of the encoder 900 may be configured to be 0.1 mm or more.

According to an embodiment of the present disclosure, the protrusion 910 of the encoder 900 may be configured to contact the inner ring 300 with an interference amount of 0.1 mm or more.

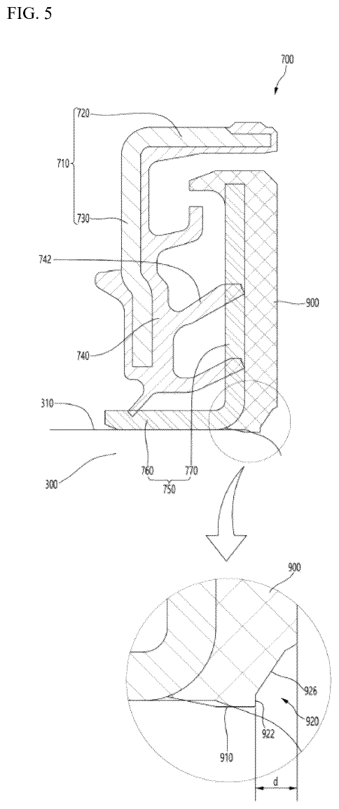

Meanwhile, referring to FIGS. 5 to 8, other embodiments of an inboard-side sealing member 700 applicable to a vehicular wheel bearing 100 according to an embodiment of the present disclosure are exemplarily shown.

The embodiments shown in FIGS. 5 to 8 differ from the embodiments described above with reference to FIGS. 3 and 4 only in a protrusion 910 provided on an inner circumferential surface of the encoder 900 and peripheral structures thereof, as shown in the drawings. Accordingly, only such differences will be briefly described below, and detailed descriptions of the remaining portions will be omitted.

According to an embodiment of the present disclosure, the stepped portion 920 of the encoder 900 may be modified and implemented to another structure (e.g., a structure shown in FIG. 5) different from that shown in FIG. 4.

According to an embodiment of the present disclosure, as shown in FIG. 5, the stepped portion 920 may be modified to have a structure comprising an inclined surface 926 extending obliquely with respect to a rotational central axis.

For example, as shown in FIG. 5, the stepped portion 920 may be modified to have a structure comprising an axial end surface 922 extending in a direction perpendicular to the rotational central axis and an inclined surface 926 extending obliquely with respect to the rotational central axis.

According to an embodiment of the present disclosure, an end portion of the stepped portion 920 may be provided with an additional inclined surface as shown in FIG. 5, or may be provided with a chamfered portion as shown in FIGS. 3 and 4.

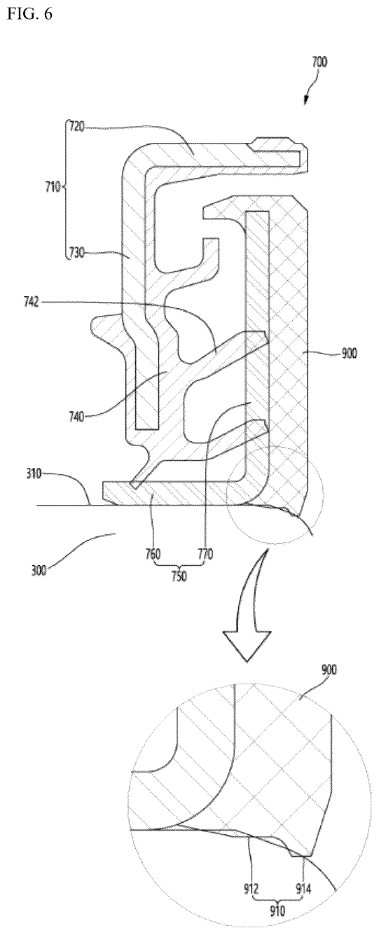

According to an embodiment of the present disclosure, the protrusion 910 of the encoder 900 may be configured to have a two-step stepped structure having two different diameters, as shown in FIG. 6.

For example, the protrusion 910 of the encoder 900 may be configured to comprise a first protrusion 912 positioned axially outward and a second protrusion 914 positioned axially inward, and an inner circumferential surface of the second protrusion 914 may be formed to have a diameter smaller than that of an inner circumferential surface of the first protrusion 912.

According to an embodiment of the present disclosure, the first protrusion 912 and the second protrusion 914 may be configured to respectively contact the inner ring 300 at positions spaced apart from each other.

With this configuration, since the protrusion 910 provided on the inner circumferential surface of the encoder 900 is configured to make dual contact with the inner ring 300 at a plurality of spaced positions, inflow of foreign substances such as moisture into a press-fitting surface between the inner portion 750 and the inner ring 300 can be more effectively prevented.

In addition, due to the two-step protrusion contact structure formed by the first protrusion 912 and the second protrusion 914, it becomes possible to adjust stress concentration of the protrusion 910 of the encoder 900 that undergoes elastic deformation.

According to an embodiment of the present disclosure, the first protrusion 912 and the second protrusion 914 may each be configured to contact the inner ring 300 with an interference amount of 0.05 mm or more.

Meanwhile, according to an embodiment of the present disclosure, unlike the foregoing embodiments, the protrusion 910 of the encoder 900 may be formed as a single-step protruding structure.

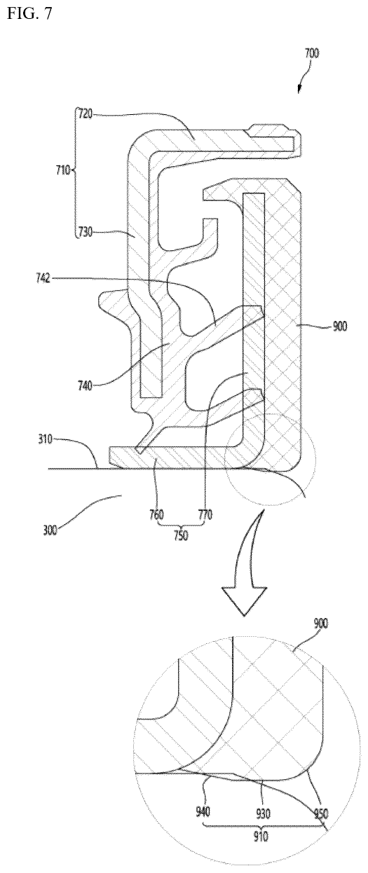

For example, according to an embodiment of the present disclosure, as shown in FIG. 7, the protrusion 910 of the encoder 900 may be configured to comprise a cylindrical portion 930, an inclined portion 940 provided axially outward of the cylindrical portion 930, and a rounding portion 950 provided axially inward of the cylindrical portion 930.

According to an embodiment of the present disclosure, the inclined portion 940 may be formed as an inclined surface structure in which a diameter increases as the inclined portion 940 extends axially away from the cylindrical portion 930, and the rounding portion 950 may be formed as an arcuate structure having a predetermined radius of curvature.

As such, when the protrusion 910 provided on the inner circumferential surface of the encoder 900 is formed in a combined shape including the inclined portion 940 formed on one side and the rounding portion 950 formed on the other side, it is possible to secure sufficient axial thickness of the protrusion 910 while reducing a risk of deterioration in manufacturability of the encoder 900 or occurrence of damage thereto.

According to an embodiment of the present disclosure, the protrusion 910 of the encoder 900 may be configured such that at least one of the inclined portion 940 and the cylindrical portion 930 contacts the inner ring 300 (for example, with an interference amount of 0.1 mm or more with respect to the inner ring 300), and the rounding portion 950 may be formed as an arcuate structure having a radius of curvature of 0.1 mm or more.

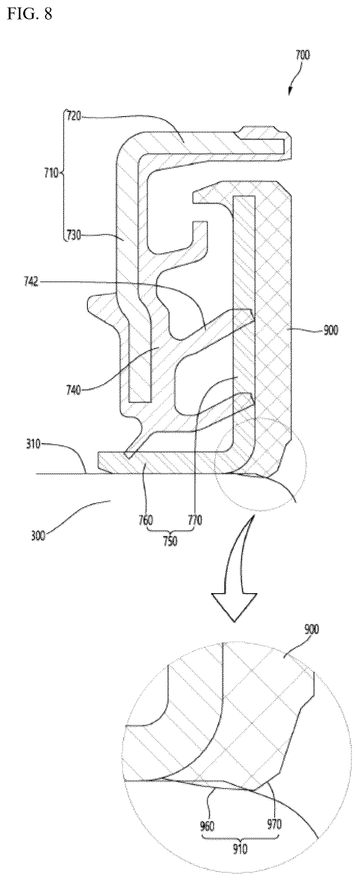

Meanwhile, according to an embodiment of the present disclosure, the protrusion 910 of the encoder 900 may be formed so as not to comprise a cylindrical inner circumferential surface portion, as shown in FIG. 8.

For example, according to an embodiment of the present disclosure, as shown in FIG. 8, the protrusion 910 of the encoder 900 may be formed in a structure combining an arcuate portion 960 and a chamfer portion 970.

According to an embodiment of the present disclosure, the arcuate portion 960 positioned axially outward may be formed as a rounded structure having a predetermined radius of curvature, and the chamfer portion 970 positioned axially inward may be formed as an inclined structure in which a diameter increases toward an axially inner side.

According to an embodiment of the present disclosure, in the embodiment illustrated in FIG. 8, the protrusion 910 of the encoder 900 may be configured to contact the inner ring 300 at the arcuate portion 960 (for example, with an interference amount of 0.1 mm or more with respect to the inner ring 300), and the arcuate portion 960 may be formed to have a radius of curvature of 0.1 mm or more.

Although the present disclosure has been described above with reference to specific matters such as particular constituent elements and limited embodiments, these embodiments are provided only to assist in a more comprehensive understanding of the present disclosure, and the present disclosure is not limited thereto. Rather, various modifications and variations may be made from such descriptions by a person having ordinary skill in the art to which the present disclosure pertains.

Accordingly, the spirit of the present disclosure should not be construed as being limited to the embodiments described above, and not only the claims set forth below but also all modifications and variations that are equivalent or substantially equivalent to the scope of the claims should be understood as falling within the scope of the spirit of the present disclosure.

### EXPLANATION OF REFERENCE NUMERALS

100: vehicular wheel bearing
200: wheel hub
300: inner ring
400: rolling element
500: sealing member
600: outboard-side sealing member
700: inboard-side sealing member
710: outer portion
720: cylindrical press-fitting portion (of the outer portion)
730: flange portion (of the outer portion)
740: elastic sealing portion
750: inner portion
760: cylindrical press-fitting portion (of the inner portion)
770: flange portion (of the inner portion)
900: encoder
910: protrusion
912: first protrusion
914: second protrusion
920: stepped portion
930: cylindrical portion
940: inclined portion
950: rounding portion
960: arcuate portion
970: chamfer portion

What is claimed is:

1. A vehicular wheel bearing (100) for rotatably mounting and supporting a vehicle wheel to a vehicle body, comprising:
a wheel hub (200) to which the vehicle wheel is mounted and which rotates together with the vehicle wheel;
at least one inner ring (300) mounted to the wheel hub (200);
an outer ring (400) fixedly coupled to a vehicle-body-side member;
a plurality of rolling elements (500) configured to rotatably support the wheel hub (200) and the inner ring (300) relative to the outer ring (400);
an outboard-side sealing member (600) configured to perform sealing at an outer axial end portion of a bearing space in which the rolling elements (500) are disposed; and
an inboard-side sealing member (700) configured to perform sealing at an inner axial end portion of the bearing space in which the rolling elements 500 are disposed,
wherein the inboard-side sealing member (700) comprises an outer portion (710) mounted to the outer ring (400) in a press-fitted manner, and an inner portion (750) mounted to the inner ring (300) in a press-fitted manner,
wherein an encoder (900) for wheel-speed detection is provided on one side of the inner portion (750),
wherein a protrusion (910) extending radially inward is formed on an inner circumferential surface of the encoder (900),
wherein the protrusion (910) of the encoder (900) is formed to have an inner diameter smaller than an outer diameter of an outer circumferential surface (310) of the inner ring (300) to which the inner portion (750) is mounted, in an undeformed state before assembly, and
wherein the protrusion (910) of the encoder (900) is configured to contact the inner ring (300) in an assembled state.

2. The vehicular wheel bearing according to claim 1, wherein an axially inner portion of the protrusion (910) is provided with a stepped portion (920) having a structure recessed radially outward.

3. The vehicular wheel bearing according to claim 2,
wherein the stepped portion (920) comprises an axial end surface (922) perpendicular to a rotational central axis of the wheel bearing, and an inner circumferential surface (924) parallel to the rotational central axis of the wheel bearing, and
wherein the inner circumferential surface (924) of the stepped portion (920) is formed to have a diameter larger than that of the outer circumferential surface (310) of the inner ring (300) to which the inner portion (750) is mounted.

4. The vehicular wheel bearing according to claim 2, wherein the stepped portion (920) comprises an axial end surface (922) perpendicular to a rotational central axis of the wheel bearing, and an inclined surface (926) extending obliquely with respect to the rotational central axis of the wheel bearing.

5. The vehicular wheel bearing according to claim 1,
wherein the protrusion (910) is configured to contact the inner ring (300) with an interference amount of 0.1 mm or more.

6. The vehicular wheel bearing according to claim 5, wherein an axial length d from an axial end surface (922) of a stepped portion (920) to an axial end surface of the encoder (900) is 0.1 mm or more.

7. The vehicular wheel bearing according to claim 1,
wherein the protrusion (910) of the encoder (900) comprises a first protrusion (912) positioned axially outward and a second protrusion (914) positioned axially inward, and
wherein an inner circumferential surface of the second protrusion (914) is formed to have a diameter smaller than that of an inner circumferential surface of the first protrusion (912).

8. The vehicular wheel bearing according to claim 7, wherein the first protrusion (912) and the second protrusion (914) are configured to respectively contact the inner ring (300) at positions spaced apart from each other.

9. The vehicular wheel bearing according to claim 8, wherein each of the first protrusion (912) and the second protrusion (914) is configured to contact the inner ring (300) with an interference amount of 0.05 mm or more.

10. The vehicular wheel bearing according to claim 1, wherein the protrusion (910) of the encoder (900) comprises a cylindrical portion (930), an inclined portion (940) provided axially outward of the cylindrical portion (930), and a rounding portion (950) provided axially inward of the cylindrical portion (930).

11. The vehicular wheel bearing according to claim 10, wherein the rounding portion (950) is formed as an arcuate structure having a radius of curvature of 0.1 mm or more.

12. The vehicular wheel bearing according to claim 11, wherein the protrusion (910) is configured such that at least one of the inclined portion (940) and the cylindrical portion (930) contacts the inner ring (300) with an interference amount of 0.1 mm or more.

13. The vehicular wheel bearing according to claim 1, wherein the protrusion (910) of the encoder (900) comprises an arcuate portion (960) having a predetermined radius of curvature, and a chamfer portion (970) positioned axially inward relative to the arcuate portion (960).

14. The vehicular wheel bearing according to claim 13, wherein the arcuate portion (960) is formed as an arcuate structure having a radius of curvature of 0.1 mm or more.

15. The vehicular wheel bearing according to claim 14, wherein the protrusion (910) is configured to contact the inner ring (300) at the arcuate portion (960) with an interference amount of 0.1 mm or more.
